(19) United States
(12) Patent Application Publication
(10) Pub. No.: US 2010/0325783 A1
(43) Pub. Date: Dec. 30, 2010

(54) ARTICLE COMPRISING A RUBBER COMPONENT AND A THERMOPLASTIC COMPONENT, AND ITS MANUFACTURE

(75) Inventors: Matthew James Hodgson, Wiltshire (GB); Philip Adam Smith, Wiltshire (GB)

Correspondence Address: MCGARRY BAIR PC, 32 Market Ave. SW, SUITE 500, GRAND RAPIDS, MI, 49503, US

(73) Assignee: AVON POLYMER PRODUCTS LIMITED, Melksham, Wiltshire, GB (GB)

(21) Appl. No.: 12/675,303

(22) PCT Filed: Aug. 20, 2008
(86) PCT No.: PCT/GB08/02827

§ 371 Date: Sep. 14, 2010

(30) Foreign Application Priority Data
Aug. 28, 2007 (GB) 0716707.5
Aug. 20, 2008 (WO) PCTGB2008002827

(51) Int. Cl. A42B 1/06; B32B 37/06; B32B 25/08; A41D 3/08

(52) U.S. Cl. 2/410; 156/275.1; 428/423.9; 2/84

(57) ABSTRACT

A process for making an article comprising a thermoplastic component (4) and a rubber component (3) having an halogenated surface in which the thermoplastic component is welded directly to the halogenated surface of the rubber component by, for example, RF or impulse welding. The product comprises a rubber component having an halogenated surface and a thermoplastic component in which the halogenated surface of the rubber component and the thermoplastic component are fused together.

The present invention relates to a process for the manufacture of articles comprising rubber and thermoplastic components and in particular for a process of joining rubber and thermoplastic components together, and to articles made by the process.

Rubber has a long history of use in manufactured goods. For example, rubber seals are widely used in clothing and protective garments where it is desired to form a seal between the body of a person wearing the garment and the garment itself. One type of garment which typically includes rubber seals is the dry suit. Dry suits are typically made from panels of polymer impregnated fabric which are sewn together to form the bulk of the garment. However, the polymer impregnated fabric lacks the necessary elasticity and resilience to form a good seal against the wearer's neck, wrists and ankles and in those places in the dry suit typically includes a rubber seal for that purpose. A further instance is the type of protective hood used by emergency service personnel to protect themselves in the event of chemical, biological, radiological or nuclear event. Such hoods are known as CBRN hoods and conventionally comprise a transparent thermoplastic polyurethane hood portion which covers the head and includes a respirator filter to which the user can breathe. The hood portion is sealed around the wearer's neck with a rubber seal.

The joins between the rubber seals and the thermoplastic polyurethane components should be both strong and free of leaks. Conventional methods of joining rubber seals to polyurethane include using an adhesive such as double-sided adhesive tape, together with stitching for reinforcement. Such methods are labour intensive and inconvenient. For example, a known method of manufacturing a protective CBRN hood involves joining the rubber neck seal to the transparent polyurethane hood using double-sided adhesive tape which requires careful positioning of the seal and hood and a lengthy stepwise procedure bringing the components together with the double-sided tape.

Attempts have been made to provide simpler and more robust methods of joining rubber seals to thermoplastic polymers such as polyurethane. GB 2 355 216A discloses a process in which a rubber neck or cuff seal for a dry suit comprising a dipped rubber layer is coated with a thermoplastic layer such as a polyurethane. The coated seal may then be welded to the rest of the garment by a welding process which involves fusing the polyurethane polymer of the surface coating of the seal.

There remains a need for improved processes of joining rubber and a thermoplastic such as polyurethane together.

The present invention relates to a process of making an article comprising a thermoplastic component and a rubber component having a halogenated surface, the process comprises the step of welding the thermoplastic component directly to the halogenated surface of the rubber component. It has previously been believed that it is not possible to join a rubber directly to a thermoplastic such as polyurethane in a satisfactory manner using welding. Surprisingly, the present inventor has found that it is possible to achieve a strong and leak-free join between rubber and thermoplastic components by welding provided that the surface of the rubber component in the region of the weld has previously been halogenated. The inventor believes that the halogenated surface of the rubber has a degree of thermoplasticity which allow it to be welded to a thermoplastic polymer such as polyurethane.

In the process of the invention, the thermoplastic component is welded directed to the halogenated surface of the rubber component, that is, there are no intervening layers or materials between the thermoplastic and the halogenated surface. The thermoplastic and halogenated rubber therefore fuse together during the welding step, in contrast to the process of GB 2 355 216A in which the body of the garment is welded to the polyurethane coating of the rubber seal.

The rubber component may be of any natural or synthetic rubber which is capable of being halogenated to provide a halogenated surface. Synthetic rubbers are well known to the skilled person and include bromo butyl rubber (BIIR), butadiene rubber (BR), chloro butyl rubber (CIIR), chloroprene rubber (CR), hydrogenated nitrile rubber (HNBR), butyl rubber (IIR), isoprene rubber (IR) including natural rubber (NR), nitrile rubber (NBR), and styrene-butadiene rubber (SBR). Preferably, the rubber component is of isoprene rubber, especially natural rubber. Isoprene rubber components are usually produced in one of two ways. In the first way, a pre-cured latex is spread onto a horizontal belt, cured using heat, passed through a trough of talc to reduce surface tackiness and is then collected onto rolls. The sheet material is then halogenated, if desired, and cut to the desired shape. In the second method, an aluminium sheet is coated with a coagulant and then dipped into a bath of natural rubber latex. The sheet is lifted and the latex remaining on the sheet coagulates to form a rubber sheet. That rubber sheet is then halogenated, if desired, and cut to the desired shape. The rubber component may be made by either of those methods or by any other suitable method.

High levels of contaminants such as talc or silicone oil on the surfaces of rubber component, if present, may interfere with the welding process or otherwise reduce the strength of the weld and where excessive levels of talc or silicone are present, the process of the invention may include the step of removing at least some of the talc or silicone prior to the welding step. The talc or silicone can be removed by conventional washing and cleaning processes.

The halogenation of natural rubber components such as natural rubber seals is well known and is typically carried out in order to reduce the surface tackiness of the rubber so that it slips easily over the skin and to reduce the amount of extractable protein present, thereby lowering the risk of an allergic reaction in the wearer. The halogenation typically involves treating the rubber component with a solution of the appropriate halogen. Those conventional methods have been found to produce a satisfactory halogenated surface for use in the process of the invention although any suitable halogenation technique may be used. Preferably, the rubber component is chlorinated. (References herein to halogenation, chlorination, or bromination should be taken to refer to the above-mentioned surface treatment and not to refer to any halogen present as a constituent of the rubber polymer repeat unit, such as the bromine in bromo butyl rubber and the chlorine in chlorobutyl rubber.)

For the process of the invention to work it is not necessary for the whole surface of the rubber component to be halogenated; it is sufficient that only the region to be welded is halogenated. Accordingly, the surface of the rubber article may include one or more regions which are not halogenated. Preferably, substantially all of the rubber component is halogenated (although any cut edges of the rubber component formed by cutting or stamping the component from a sheet of rubber will typically not be halogenated).

The level of halogenation may vary within a wide range. The halogenation level of the surface of the rubber component may, for example, be within the range of from 0.1 to 20%, optionally from 0.1 to 10%, preferably from 0.5 to 3.5%, and more preferably in the range of from 1 to 3%. The halogenation level can be determined using fluorescence spectroscopy, for example, using an x-ray fluorescence analyser of the type available from ASOMA Instruments of Austin, Tex. which is now part of the SPECTRO group. The ASOMA analyser shines x-rays of 5.9 keV onto the sample and chlorine atoms, if present, emit x-rays at 2.62 keV. Those x-rays are detected and the rate of emission of the x-rays is compared with a calibration curve prepared using samples of known chlorine content to give the chlorine content of the sample.

The rubber component may be of any size and/or shape. The rubber component may be, for example, a component made of rubber sheet cut to a specific desired shape. Where the rubber component is made from a rubber sheet material the thickness of the rubber sheet material is preferably within the range of from 100 microns to 2.0 millimetres. In a preferred embodiment, the rubber component is a seal. The seal may be, for example, a seal for use in an opening of a garment to seal the garment to the wearer's body, for example, a neck, wrist or ankle seal.

The thermoplastic component may be of any thermoplastic which is weldable to the halogenated surface of the rubber component. Optionally, the thermoplastic of the thermoplastic component has a melting point in the range of from 130° C. to 220° C. The thermoplastic should be able to withstand the elevated temperatures involved in the welding step without significant decomposition. The thermoplastic of the thermoplastic component may contain one or more plasticisers to modify the softening point of the thermoplastic material. The thermoplastic component may also comprise one or more other materials such as fillers, pigments, antioxidants and the like. The important point is that the thermoplastic should be able to melt during the welding step and become welded to the halogenated surface of the halogenated rubber component.

The thermoplastic component may be of any weldable thermoplastic, for example a polyurethane or polyvinylchloride. Preferably, the thermoplastic component is of a thermoplastic which is suitable for RF welding such as polyurethanes, polyvinylchloride, nylons, PET, EVA and some ABS resins. RF welding the nylons, PET, EVA and some ABS resins may require special conditions, for example, nylon and PET are RF weldable if preheated welding bars are used in addition to the RF power. In a preferred embodiment, the thermoplastic component is a polyurethane component. The polyurethane may be a semi-crystalline polyurethane. In a preferred embodiment, the polyurethane component is an semi-crystalline polyurethane sheet material suitable for fabrication of a protective CBRN hood. The polyurethane sheet material may be of any suitable thickness. Optionally, the thickness of the polyurethane sheet material is in the range of 100 microns to 1000 microns. Below 100 microns thickness the chemical barrier properties of polyurethane may decline and above 1000 microns flexibility and wearability may reduce. Advantageously, the polyurethane sheet is transparent, that is, is optionally clear. Polyurethane has the further advantage that it is typically very resistant to chemical attack and is therefore suitable for use in protective garments such as protective hoods.

The polyurethane component may be of a crystalline polyurethane. Crystalline polyurethanes are used, for example in the filter housings of protective hoods.

Preferably, the polyurethane does not contain a plasticiser. The skilled reader will understand that the thermoplastic component may comprise one or more elements of non-thermoplastic material, for example metal studs, stitching and the like, which do not take part in the welding. For example, the thermoplastic component could be of a laminate material having a thermoplastic layer, which is involved in the welding step, adhered to a non-thermoplastic substrate. In a similar way, the rubber component may also comprise non-rubber elements which take no part in the welding step. Preferably, however, the thermoplastic component is free of non-thermoplastic elements and the rubber component is free of non-rubber elements.

Any suitable welding technique may be used to fuse together the thermoplastic component and the halogenated surface of the rubber component. For example, impulse welding, RF welding, heated platen welding or continuous heat sealing (also known as band sealing) may be used. Impulse welding and RF welding are preferred welding methods. The welding process preferably involves pressing the thermoplastic component against the halogenated surface of the rubber component and then welding the two components together in the area of contact.

Impulse welding is a well-known method of welding which typically involves welding two thermoplastic components by clamping them together in close contact with a shielded heating element. Impulse welding has the advantage that it is suitable for use with thermoplastics of both high and low polarity and can therefore weld well thermoplastics which are less suitable for RF welding by virtue of having relatively low polarity, such as polyester polyurethanes. The equipment required for impulse welding may also be significantly less costly than that required for RF welding.

The optimum conditions employed in the impulse welding will in general depend on a number of factors and it is within the ability of the skilled person to adjust the welding conditions accordingly. The present inventor has found, for example, that where the thermoplastic component is a polyurethane film having a thickness in the range of from 100 to 300 microns, and the rubber component is an isoprene film having a thickness in the range of from 0.4 to 0.6 mm and is chlorinated to a level of 2%, an impulse weld time of around six seconds, a weld temperature of around 165° C. and a weld pressure of around 0.1N/mm² or more has produced welds of excellent strength.

In another preferred embodiment, the welding is RF welding (Radio Frequency welding). RF welding is a form of induction welding which is particularly suited to the welding of polymeric materials. The skilled person will be aware that the particular RF welding conditions required for a particular seal will depend on a number of factors including the chemical nature of the materials to be joined and the shape and size of the desired weld. The optimum conditions will in general involve a balance of the pressure applied along the weld line, the weld power and the time over which the weld power is applied. Preferably, the RF weld power is at least 1.0 kW. Preferably the weld time is at least 1.0 seconds. Optionally, the weld frequency will be in the region of 27.120 megahertz. For a process in which a natural rubber neck seal having a thickness of 500 microns is welded to a hood portion of a transparent flexible polyurethane sheet material of a thickness of 250 microns and in which the rubber has a chlorination level of 2%, the present inventor has found that an RF weld power of 2.2 kW, a weld time of 5.5 seconds and a weld pressure of 0.6 Newtons per mm² at a weld frequency of 27.120 megahertz has produced welds which generally are free of leaks and of excellent strength.

Heated platen welding generally involves mounting a shaped metal tool in a press and heating it. The components to be welded are then laid up between a platen and the tool, the press is brought together and sealing pressure is applied around the tool profile.

Continuous heat sealing or band sealing generally involves feeding components in sheet or film form between rotating elements which create long welds.

The weld may be a 2D weld (i.e. the weld is one plane) or a 3D weld.

The process of the invention is applicable to the manufacture of any article in which it is desired to join a rubber component having a halogenated surface to a suitable thermoplastic component. In a preferred embodiment the article is a garment, and the rubber component is a rubber seal within the garment. In a particular preferred embodiment the article is a protective hood for emergency use such as a CBRN hood, the rubber component is a rubber neck seal and the thermoplastic component is a transparent polyurethane hood which is to be welded to the neck seal. In a further preferred embodiment, the rubber component is a rubber mask, such as a gas mask, and the thermoplastic component is a transparent polyurethane visor, which is to be welded to the rubber mask. Alternatively, the article may be a dry suit. In that case the rubber component will typically be a neck, wrist or ankle seal and the thermoplastic component will be the body of the dry suit which is typically made of polyurethane coated fabric.

In a further aspect the invention provides an article comprising a rubber component having a halogenated surface and a thermoplastic component in which the halogenated surface of the rubber component and the thermoplastic component are fused together. Thus, the halogenated rubber is fused with and thereby bonded directly to the thermoplastic of the thermoplastic component.

Embodiments of the process of the invention will be explained below for the purpose of illustration only, with reference to drawings in which:

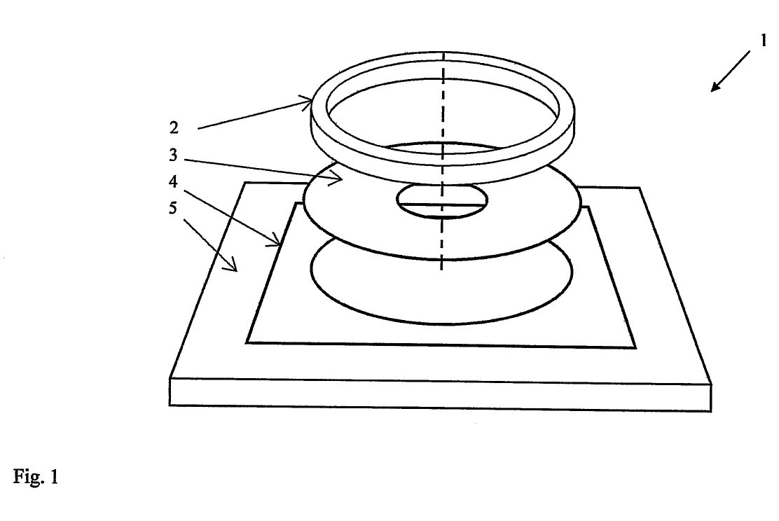

FIG. 1 shows a simplified exploded perspective view of a welding assembly for use in the process of the invention;

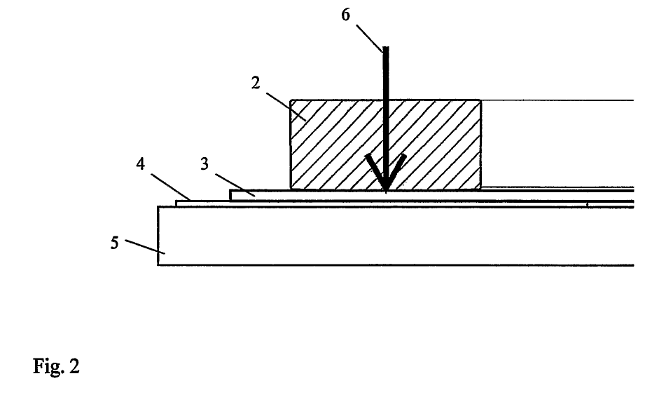

FIG. 2 shows a cross section through a part of the welding assembly of FIG. 1;

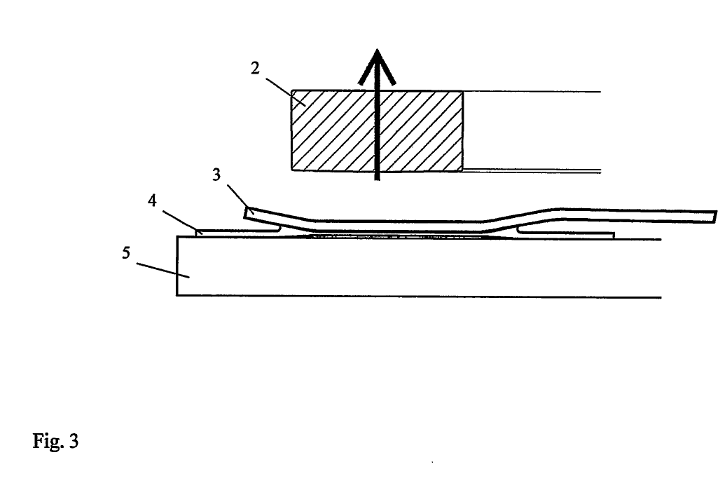

FIG. 3 shows a cross section similar to that shown in FIG. 2 but immediately following the welding step;

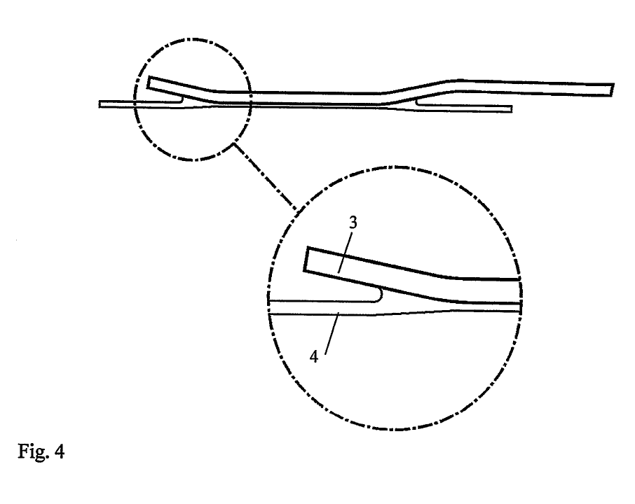

FIG. 4 shows the detail of part of the welded assembly; and

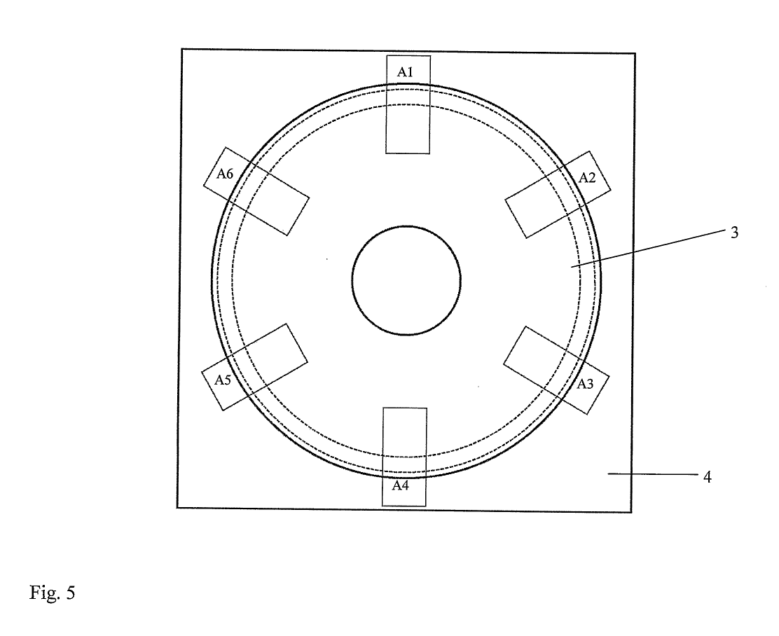

FIG. 5 shows the positions of six samples taken from the assembly of FIG. 4 for use in peel and shear strength testing.

FIG. 1 shows a simplified exploded view of assembly 1 of components arranged to be RF welded according to one embodiment of the process of the invention. The assembly 1 comprises a weld ring 2, a circular neck seal 3 consisting of 0.5 mm synthetic isoprene chlorinated to 2%, a polyurethane component 4 consisting of a section of 0.274 mm thick TUFTANE TFL-1E polyurethane sheet (obtained from Permali of Gloucester, UK), and a weld platen 5.

The components were brought together such that the isoprene component 3 and the polyurethane component 4 were clamped between the weld ring 2 and the weld platen 5 as shown in FIG. 2. Pressure was applied in the direction of the arrow 6 and the RF welding was commenced. The weld power was 2.75 kW and the weld cycle was 0.5 seconds pre-weld, 6.5 seconds of welding time and 1.0 second of dwell time. The weld tool temperature was 51° C. and the nominal weld pressure was 6 bar. Following the welding step, the pressure was released and the weld ring 2 was lifted away as shown in FIG. 3. FIG. 4 shows in detail a section through the welded sample showing that the polyurethane had bonded to the halogenated surface of the rubber component 3.

Six rectangular 25×70 mm samples A1 to A6 were cut from the welded assembly as shown in FIG. 5 and were each subjected to shear and peel strength tests. The same tests were carried out on a similar sample prepared according to the method of the invention using impulse welding rather than RF welding. The results, along with results for assemblies fixed with conventional adhesive tape, are shown in the table. Accordingly, it can be seen that in this example the welding process gave the join between the isoprene component and the polyurethane component of significantly higher shear and peel strength than achieved using conventional adhesive tape.

| | Mean Shear Strength | Mean Peel Strength |
|---|---|---|
| Welding Method | (N/mm) | (N/mm) |
| RF Weld | 1.75 | 0.98 |
| Impulse Weld | 1.97 | 1.59 |
| Typical Tape Joint | 0.78 | 0.54 |

Whilst the present invention has been described and illustrated with reference to a particular embodiment it will be appreciated by those of ordinary skill in the art that the invention lends itself to many different variations not illustrated herein. For that reason, reference should be made to the claims to determine the true scope of the present invention.

1. A process of making an article comprising a thermoplastic component and a rubber component having a halogenated surface, the process comprising the step of welding the thermoplastic component directly to the halogenated surface of the rubber component.

2. A process as claimed in claim 1 in which in the rubber component is a natural rubber component.

3. A process as claimed in claim 1 in which the rubber component is a synthetic rubber component.

4. A process as claimed in claim 1 in which the rubber component is a seal.

5. A process as claimed in claim 1 in which the halogenated surface of the rubber component is halogenated to a level in the range of from 0.1 to 20%.

6. A process as claimed in claim 1 in which the halogenated surface of the rubber component is chlorinated.

7. A process as claimed in claim 1 in which the thermoplastic component is a flexible thermoplastic sheet material.

8. A process as claimed in claim 1 in which the thermoplastic component is a polyurethane component.

9. A process as claimed in claim 8 in which the polyurethane component is transparent.

10. A process as claimed in claim 1 in which the article is a garment.

11. A process as claimed in claim 1 in which the article is a protective hood.

12. A process as claimed in claim 11 in which the polyurethane component is a hood portion of a protective hood.

13. A process as claimed in claim 1 in which the welding is RF welding, impulse welding, heated platen welding or continuous heat sealing.

14. A process of making a garment comprising a polyurethane component and a natural rubber seal, in which the natural rubber seal has a halogenated surface and the process comprises the steps of bringing the polyurethane component into contact with the halogenated surface of the natural rubber seal and RF welding or impulse welding the polyurethane component to the halogenated surface of the rubber seal.

15. An article comprising a rubber component having a halogenated surface and a thermoplastic component in which the halogenated surface of the rubber component and the thermoplastic component are fused together.

16. An article as claimed in claim 15 wherein the article is a garment.

17. An article as claimed in claim 15 wherein the article is a protective hood, the thermoplastic component is a transparent polyurethane hood, the rubber component is a halogenated rubber seal, and the halogenated rubber seal is welded to the transparent polyurethane hood.
